(19) United States
(12) Patent Application Publication
(10) Pub. No.: US 2023/0035654 A1
(43) Pub. Date: Feb. 2, 2023

(54) CLAMPING APPARATUS

(71) Applicant: Miba Battery Systems GmbH, Bad Leonfelden (AT)

(72) Inventor: Martin REINGRUBER, Vorderweissenbach (AT)

(73) Assignee: Miba Battery Systems GmbH, Bad Leonfelden (AT)

(21) Appl. No.: 17/791,747

(22) PCT Filed: Jan. 5, 2021
(86) PCT No.: PCT/AT2021/060003

§ 371 Date: Jul. 8, 2022

(30) Foreign Application Priority Data
Jan. 9, 2020 (AT) A50007/2020

(51) Int. Cl. H01M 50/516; H01M 50/528; H01M 50/536

(52) U.S. Cl. CPC H01M 50/516; H01M 50/528; H01M 50/536; H01M 2220/20

(57) ABSTRACT

A clamping device for clamping at least one cell for storing electrical energy includes a downholder ,by which a cell connector can be placed on the cell or the cells without gaps at least in some sections, wherein for each cell a separate downholder is provided, wherein the downholder(s) can be tensioned against the cell or the cells.

The invention relates to a clamping device for clamping one or multiple cells for storing electrical energy, comprising a downholder, by means of which at least one cell connector can be placed on the cell(s) without gaps at least in some sections.

Moreover, the invention relates to a welding device for welding at least one cell connector to a cell or multiple cells for storing electrical energy comprising a clamping device for clamping the cell(s).

Additionally, the invention relates to a method for materially bonding at least one cell connector to cells for storing electrical energy using a welding device, according to which a laser beam is directed at the cell connector from a laser weld head of the welding device, and the cells are held in a clamping device.

Due to the environmental trend towards electrical drives, for example of motor vehicles, batteries with rechargeable cells have also come into the focus of development. In such batteries, a plurality of rechargeable cells are consolidated to form larger units. For this purpose, the cells of these units are connected in an electrically conductive manner. For establishing this connection, it is known to form a materially bonded connection between a bus bar and the cells by means of laser welding. For example, AT 512 756 B1 describes a battery pack for electrical energy supply, having multiple round cells in rows which are arranged offset in relation to one another, wherein the round cells have electrical poles, and having a cover plate and base plate projecting at least partially over the poles of the round cells and being connected to the round cells for mechanical retention having openings for cooling the round cells , wherein the electrically conductive cover plate and base plate are both electrically connected and materially bonded to the poles of the round cells.

The invention is based on the object of improving the production of connecting the cells to at least one cell connector.

In the initially mentioned clamping device, the object of the invention is achieved in that a separate downholder is provided for the cell or for each cell, wherein the downholder or the downholders can be or are tensioned against the cell(s).

The object of the invention is further achieved by the welding device according to the invention, in which the clamping device is formed according to the invention.

Additionally, the invention is achieved with the initially mentioned method, in which it is provided that multiple cells are connected to the cell connector or the cell connectors by means of the laser beam, without the laser weld head and the clamping device being moved.

In this regard, it is advantageous that tolerances of the at least one cell can be compensated by the at least one downholder, whereby the clamping of the at least one cell can be simplified. Additionally, in the case of a plurality of cells, less time is required for connecting the at least one cell connector to the cells due to the simultaneous clamping of the multiple cells, so that the cycle times for producing rechargeable batteries can be reduced. In this regard, the separate downholders allow for a better adaption of the tension to the cells for each of the cells, whereby particularly tolerances of the cell dimensions can also be taken into account better. In particular, the clamping device helps avoid that too great a clamping force is possibly applied to the cell or individual cells, which could lead to damage to the (respective) cell. Due to the possibility of welding multiple cells without changing the position of the clamping device or the laser weld head, infeed times to the cells can be partially avoided, whereby a corresponding cycle time reduction can be achieved.

According to a preferred embodiment variant of the clamping device, it may be provided that the downholders are arranged or formed so they can be elastically tensioned against the cells, whereby a further improvement of the effects mentioned above can be achieved. In particular, this results in that the infeed of the downholders towards the cells can be realized more easily with tolerance compensation.

According to a further embodiment variant of the clamping device, the downholder(s) can have a pin-shaped or rod-shaped design. It is thus possible to provide the downholders with a slim design, whereby the surface available for establishing the materially bonded connection between a cell and the cell connector can be increased. In this regard, it is also advantageous that the materially bonded connection may also be established very close to the edge of the contact surfaces of the cell(s).

In this regard, it may be provided according to an embodiment variant of the clamping device that the pin-shaped or rod-shaped downholder(s) are arranged so as to be inclined against the cell(s) at an angle of less than 90°, whereby the irradiation of the laser beam may be formed more simply in the connection region.

According to another embodiment variant of the clamping device, it can also be provided for that the downholder(s) has or have a sleeve-shaped design. With the sleeve-shaped embodiment of the at least one downholder, the gap-free contact of the at least one cell connector on the cell or the cells in the region of the established connection can be formed more simply, as it can be tensioned annularly against the cell(s).

In this regard, it may be provided according to a further embodiment variant of the clamping device that the sleeve-shaped downholder(s) have a conical design at least in some sections. Due to the partial cone shape, the irradiation of the laser beam into the connection region can be simplified, in particular when, in the case of multiple cells in a relative position of the clamping device to the laser weld head, the laser partially hits the surface of the cell connector at an angle that is unequal to 90°.

According to a further embodiment variant of the clamping device, it may be provided that the downholder(s) can be arranged on two opposing surfaces of the cell(s). Thus, it is possible to prepare all contact surfaces of the cell(s) (i.e. the positive poles and the negative poles) for connecting to the cell connectors such that a reclamping of the cell(s) is not required. Thus, the cycle time for establishing the materially bonded connections with the cell connectors can be further reduced.

According to a further embodiment variant of the clamping device, it may be provided that the cell(s) are mounted to be pivotable or rotatable with the downholders. With this embodiment variant, all poles of the cell(s) can be connected to the cell connectors with only one welding device and with clamping only once, by simply pivoting and/or rotating the clamping device by 180° after the first side is welded completely.

According to a further embodiment variant, it may be provided that the downholder(s) has/have an inlet for a process gas. Thus, it is possible to feed a process gas to the connecting point in a defined manner and to thus create a protective atmosphere around the connecting point.

According to an embodiment variant of the welding device, it may be provided that it has a laser welding device with a laser weld head, wherein the laser weld head is designed such that a laser beam emitted from the laser weld head reaches multiple cells, in order to thus achieve the connection, described above, of multiple cells with the at least one cell connector without changing the relative position of the clamping device and the welding device.

According to another embodiment variant of the welding device, it may be provided that it has at least two laser weld heads. With this design of the welding device, it is more easily possible to connect multiple cells simultaneously to the cell connector(s).

In this regard, it may be provided according to a further embodiment variant of the welding device that the two laser weld heads are assigned to opposing surfaces of the cells, resulting in that positive and negative poles of the cells can be welded simultaneously.

At this point, it is to be noted that in the following, only embodiment variant of the invention having multiple cells are elaborated as here, the advantages of the invention present more distinctly. However, with the invention, it is also possible to connect only a single cell with the cell connector(s), so that the explanations below also apply to the manipulation of only one cell (possibly correspondingly adapted to one cell).

For the purpose of better understanding of the invention, it will be elucidated in more detail by means of the figures below.

These show in a respectively very simplified schematic representation:

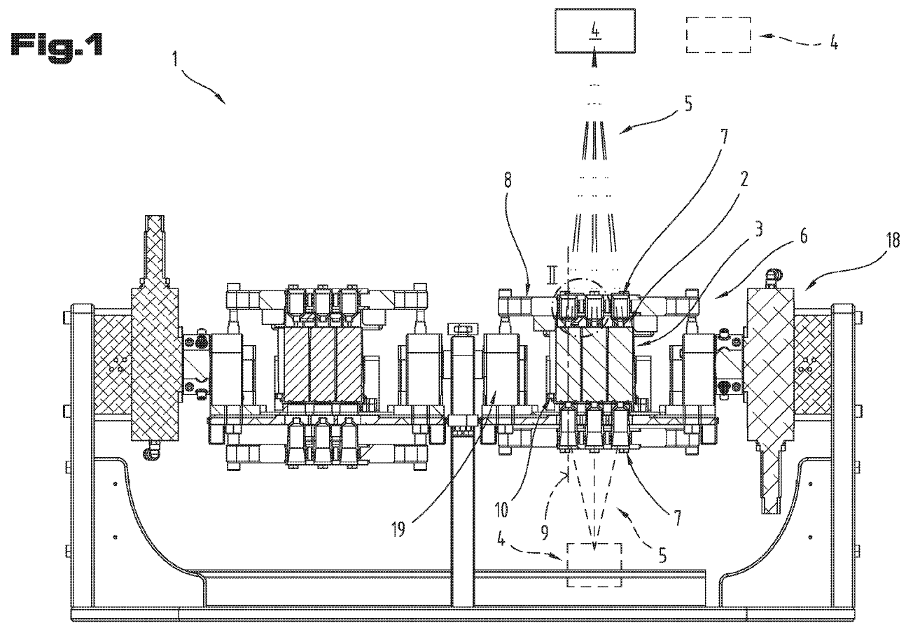

FIG. 1 a cutout from an embodiment variant of a welding device;

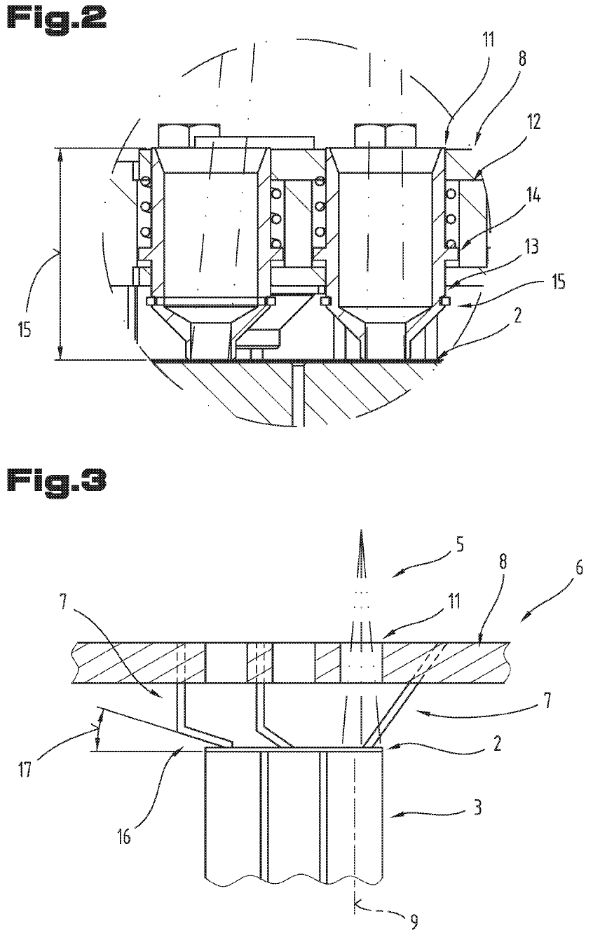

FIG. 2 a detail of the welding device according to FIG. 1;

FIG. 3 a cutout from an embodiment variant of a clamping device.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows a cutout from a welding device 1 for welding at least one cell connector 2 to cells 3 for storing electrical energy.

The cells 3 are intended for rechargeable batteries as they are used, for example, in electrically driven motor vehicles. For this purpose, multiple cells 3 can be consolidated to form so-called macro cells, and from these macro cells, larger units may in turn be produced. As this is known per se from the prior art, regarding further details, reference is made to the relevant prior art. The cells 3 are particularly lithium-ion batteries.

For establishing electrical connections between the cells 3, they are connected both in an electrically conductive and in a materially bonded manner to at least one cell connector 2 (possibly also referred to as bus bar). For this purpose, the welding device 1 is used.

It should be noted that the cell connectors 2 may be formed to be sheet metal shaped or strip shaped and/or of a different shape. They consist of a metallic material. In the preferred embodiment variant, the cell connectors 2 may be designed such that all cells 3 of a larger cell unit, such as particularly the mentioned macro cell, can be connected to one another in an electrically conductive manner by means of the cell connector 2. Depending on the type of circuitry, only the positive poles and/or only the negative poles may (each) be connected to one cell connector 2 (parallel connection) or positive and negative poles may be alternately connected to one another (series connection).

The welding device 1 in particular is a laser welding device. This laser welding device has, among other things, a laser weld head 4 which emits laser light 5. The further components of the laser welding device for generating the laser beam are not shown in further detail in FIG. 1 as they are known from the prior art.

The laser weld head 4 preferably has a plane field optical unit, i.e. that the objective focuses the laser beam onto a flat surface.

The welding device 1 may, however, also be designed based on a different technology, for example ultrasonic welding, resistance welding, etc.

In addition to the components for generating laser light, the welding device 1 also comprises a clamping device 6 for clamping the cells 3 at least while the connection between the at least one cell connector 2 and the cells 3 is being established.

At this point, it should be mentioned that the clamping device 6 can not only be used for clamping the cells 3 for connecting the at least one cell connector 2, although this is the preferred usage of the clamping device 6. The clamping device 6 may also be used for other manipulations of the cells 3.

Multiple cells 3 are held simultaneously by the clamping device 6. For example, between two and 500 cells 3 can be clamped simultaneously. However, it should again be noted that it is also possible for only a single cell 3 to be clamped by the clamping device 6, as it was already explained above.

The clamping device 6 comprises multiple downholders 7 (which may also be referred to as press-on elements). In the preferred embodiment variant, the clamping device 6 has at least one downholder 7 per cell 3. Depending on whether only one pole or both poles of the cells 3 are to be weldable with only one clamping operation, one or two downholders 7 may be provided per cell 3. In the embodiment variant of the clamping device 6 shown in FIG. 1, one downholder 7 is provided for each pole (negative and positive pole) of the cells 3, so that the downholders 7 in the depicted embodiment variant of the clamping device 6 are arranged above and below the cells 3, i.e. at opposing surfaces of the cells 3. However, according to a different embodiment variant of the clamping device 6, it is also possible that the downholders are arranged only on one side, thus for example only above or only below the cells 3.

The downholders 7 may be held in at least one downholder frame 8. The downholder frame(s) 8 is/are arranged so as to be displaceable in the direction towards and away from the cells 3, in particular displaceable linearly in the direction of longitudinal central axes 9 of the cells 3. In order to illustrate this, the left part of FIG. 1 shows the downholders 7 in the open state and the right part of FIG. 1 shows them in the closed (clamped) state. Moreover, based on this representation, it is evident that the welding device 1 may have one or multiple clamping devices 6 for the cells 3.

The downholder frame 8 may have an electrically conductive or electrically insulating design, as required, depending on whether parallel or series connections are established. Generally, the individual downholders 7 may be mounted, as required, in electrically conductive or electrically insulating guide elements, depending on whether parallel or series connections are established.

Preferably, however, the downholder frame 8 has an electrically insulating design, in particular is made from an electrically insulating material.

Clamping the cells 3 may take place manually or automatically, for example pneumatically or hydraulically. For this purpose, the cells 3 are arranged in the clamping device 6. For arranging the cells 3, a frame 10 may be provided, which may possibly remain on the cells 3 after the at least one cell connector 2 has been connected to the cells 3, and may form a sleeve of the unit of multiple cells 3, in particular the macro cell.

At least one (metallic) cell connector 2 is/are arranged between the positive poles and/or negative poles of the cells 3 and the downholders 7. Due to the clamping using the downholders 7, this at least one cell connector 2 is pressed against the cells 3 in the respective region to be connected (to be welded), so that the at least one cell connector 2 abuts on the cells 3 without gaps in the region to be connected.

In the embodiment variant shown in FIG. 1, the downholders 7 have a sleeve-shaped design. This can also be seen better in FIG. 2, which shows an enlarged view of the cutout from FIG. 1 provided with a circle. For holding the sleeve-shaped downholders 7, the at least one downholder frame 8 has corresponding recesses and/or continuous through holes 11, in which the downholders 7 are inserted.

Generally, the downholders 7 may be held in the downholder frame 8, regardless of the shape of the downholders 7.

In the simplest embodiment variant, the downholders 7 are fixed immovably, for example screwed, in the downholder frame(s) 8, so that they are pressed against the at least one cell connector 2, and thus against the cells 3, with a defined force. However, this has the disadvantage that the cells 3 should have relatively low to no tolerances with respect to its dimensions.

In order to face this, it may be provided that the individual downholders 7 are manually read-justable. In the preferred embodiment variant of the clamping device 6, however, it is provided that the downholders 7 are arranged or formed so they can be elastically tensioned against the cells 3. For this purpose, the downholders 7 may either be formed to be elastically flexible, in particular rubbery-elastic, at least in some sections, or corresponding elements, such as springs 12, in particular coil springs, are arranged, as can be seen particularly in FIG. 2. In this regard, the downholders 7 may be formed by the elastic elements themselves, such as the springs, or comprise them. The elastic tensibility may also be realized in a different manner, for example pneumatically.

The term "elastically tensible" within the meaning of the invention describes that the downholders 7 can give way in the direction of the longitudinal central axis 9 of the cells 3 from the moment of exceeding a predefinable force, which may be defined, for example, by the spring force of the spring 12, so that the contact pressure, with which the downholders 7 are pressed against the cells 3, does not exceed a certain value. Giving way may be made possible, for example by compression of the springs 12. When opening the clamping device 6, the downholders 7 return to the original position, for example by means of the release of the energy stored in the springs 12.

With this embodiment variant of the clamping device 6, different lengths of cells 3, due to tolerances, can be processed better.

In the embodiment with the springs 12, these may be arranged inside the downholder frame 8, as can be seen in FIG. 2. For this purpose, corresponding cavities may be formed in the same. The springs 12 may be arranged, for example on an outer surface 13 (the lateral surface) of the (sleeve-shaped) downholder 7, as it can also be seen in FIG. 2, and rest against an annular web 14, and/or generally a web, of the downholders 7. During clamping, after coming into contact with the at least one cell connector 2, the downholders 7 may be shifted in the direction of the longitudinal central axes 9 until the springs 12 also rest against the downholder frame 8 and are consequently compressed.

In this embodiment variant with the elastically tensible downholders 7, they can thus be arranged in the holding frame 8 so as to be displaceable through the cells 3 in the direction of the longitudinal central axes 9. In order to prevent the downholders 7 from slipping out of the downholder frame 8, corresponding (removable) safety devices 15 may be provided, by means of which the downholders 7 can come to abut on the downholder frame 8.

If the downholders 7 are formed to be at least partially rubbery-elastic, i.e. having an annular section made of an elastomer, for example, the downholders 7 in the downholder frame 8 may also be fixedly arranged as the elasticity in the direction of the longitudinal central axes 9 is provided by the downholders 7 themselves.

Generally, the downholders 7 may at least partially consist of a metallic material or of plastic. The downholders 7 may also be electrically conductive or electrically non-conductive, as required.

The sleeve-shaped downholders 7 (generally, the downholders 7 may also have a different shape) may have a cylindrical design across a total height 15. According to an embodiment variant of the clamping device 6, however, it may also be provided that the sleeve-shaped downholders 7 have a conical design at least in some sections. For example, the downholders 7 may have a conical section between two cylindrical sections, as shown in FIG. 2. However, it is also possible that the sleeve-shaped downholders 7 are completely, i.e. across the total height 15, conical. Due to these designs of the downholders 7, the size of the surface of the at least one cell connector 2 pressed onto the cells 2 can be influenced. For example, the embodiment variant shown in FIG. 2 allows for a better realization of spot welding. On the other hand, this also allows making available a relatively large surface for welding, when, in the region of the contact with the cells 3 and/or the cell connector 2, the downholders 7 have an outer diameter which is at least approximately equal to the free diameter of the respective electrical pole of the cells 3. Free diameter refers to that diameter which defines the visible surface of the electrical poles (prior to connecting to the cell connector), thus particularly the outer diameter of the cells 3 minus the ring thickness of the shrinking tube the cells 3 are usually provided with.

With the cone shape of the downholders 7, it is additionally possible to achieve that the larger opening of the sleeve-shaped downholders, not contacting the cells 3, has a greater diameter than what corresponds to the outer diameter of the cells 3. Thus, the irradiation of the laser beams (the laser light 5) in the region to be welded ca be improved. In particular, it is thus more easily avoidable that the laser beams partially hit the downholders 7.

Generally, it may be provided that, in the region of contact with the cells 3 and/or with the cell connector 2, the sleeve-shaped downholders 7 have an inner diameter, which corresponds to the free diameter of the respective electrical pole of the cells 3 and/or is smaller than it, wherein this opening should not be so small that a part of the laser beam hits the respective downholder 7.

In the embodiment variant of the welding device 1 according to FIGS. 1 and 2, the laser light 5 is guided through the sleeve-shaped downholder 7 to the respective regions to be welded.

Instead of coil springs, springs 12 of different shapes may also be used. For example, so-called omega spring can be used, meaning springs 12 having the shape of an omega. These may be made of a wire and be installed in the downholder frame(s) 8 inversely, i.e. upside down. In this regard, the springs 12 designed in such a way may also fulfill the function of the downholders 7, so that the described sleeve-shaped downholders 7 may also be dispensed with.

FIG. 3 shows cutouts of another embodiment variant of the clamping device 6.

The clamping device 6 in turn has the downholder frame 8 for holding the downholders 7. Different from the embodiment variant of the clamping device 6 described above, however, the downholders 7 are not formed to be sleeve-shaped but pin-shaped or rod-shaped. In this regard, these downholders 7 may be formed to be elastically tensible according to a further embodiment variant, for which purpose they may be formed as spring bars and/or spring pins. This elasticity may, in this regard, be provided by the downholders themselves and/or by the type of installation in the downholder frame 8.

The pin-shaped downholders 7 may have a completely straight extension, as it is shown in FIG. 3 on the basis of the right downholder 7. It is also possible that the downholders 7 have an angled design with at least one deflection 16, as it is also shown in FIG. 3. In this regard, the elastic tensibility can also be provided only by the deflection 16.

The rod-shaped and/or pin-shaped downholders 7 may have a diameter corresponding to between 5% and 30% of the diameter of the cells 3.

At this point, it should be noted that the cells 3 do not necessarily have to be round cells. They also may have a different shape, for example a cuboid shape.

The rod-shaped and/or pin-shaped downholders 7 may also be designed as solid rods and/or solid pins or hollow rods and/or hollow pins.

In the downholder frame 8, in turn, through holes 11 are formed, through which the laser light 5 is irradiated into the welding region. These through holes are located, like in the embodiment variant of the clamping device 6 described above according to FIGS. 1 and 2, in the direction of the longitudinal central axis 9 through the cells 3 above the electrical poles of the cells 3. In contrast to the sleeve-shaped downholders 7, the rod-shaped and/or pin-shaped downholders 7 are, however, not arranged in these through holes 11 but rather are preferably mounted next to the through holes 11 on the downholder frame 8. In principle, however, it is also possible the arrange the rod-shaped and/or pin-shaped downholders 7 in the through holes 11, wherein possibly, more than one downholder 7 per through hole 11 is arranged, for example two or three or four, etc. Generally, multiple downholders 7 can be arranged per region to be welded.

According to a further embodiment variant of the clamping device 6, it may be provided that the pin-shaped or rod-shaped downholders 7 are arranged so as to be inclined against the cells 3 at an angle 17 of less than 90°. In particular, this angle may amount to between 5° and 89°, preferably between 5° and 60°. In this regard, the entire downholder 7 or only the deflection 16 may be arranged at that angle 17, so that the rest of the downholder 7 may also extend orthogonally to the downholder frame 8.

As already explained, the clamping device 6 may have the downholders 7 only on one side of the cells 3, that is for example only in the region of the negative poles or only in the region of the positive poles, or in the case of partial polarity reversal of the cells 3, in the region of the positive and negative poles of the cells 3 arranged in one plane. However, according to an embodiment variant in this regard, it may also be provided that the downholders 7 are arrangea-ble on two surfaces (poles) of the cells 3 located opposite of one another in the direction of the longitudinal central axis 9, as it is shown by the embodiment of the clamping device according to FIG. 1.

According to a further embodiment variant of the clamping device 6 also shown in FIG. 1, it may be held in a pivotable or rotatable manner, so that the cells 3 are also mounted so as to be pivotable or rotatable with the downholders 7. This is evident from FIG. 1 based on a comparison of the right and left sides. In this regard, the clamping device 6 may be designed to be pivotable about at least 180°.

Thus, it is possible that not only one side of the cells 3 is made to face the laser light 5, but that, by rotating the clamping device 6, the other side can also be made to face the laser light 5. Thus, both poles of the cells 3 can be connected to the respective cell connectors 2 in a materially bonded and electrically conductive manner without the necessity of reclamping the cells 3 for this purpose.

For rotatable holding, the clamping device 6 may have cheeks 18, 19, which are rotatably or pivotably held on a frame of the welding device 1.

According to a different embodiment variant of the welding device 1, however, it may also be provided that it has a further laser weld head and/or generally a weld head, so that both poles of the cells 3 are assigned one weld head each. For example, in the embodiment variant of the welding device 1 according to FIG. 1, it is also possible for a laser weld head 4 to be arranged below the cells 3, via which laser weld head 4 laser light 5 can be irradiated into the sleeve-shaped downholders 7, which are arranged below. Thus, it is also possible to weld both electrical poles of a cell 3 simultaneously.

According to an embodiment variant of the welding device 1 in this regard, however, it may also be provided that the at least two weld heads are assigned to only one side of the cells 3 (as it is illustrated in dashed lines in FIG. 1), so that multiple electrical poles of one side of the cells 3 can be welded simultaneously.

According to a further embodiment variant of the clamping device 6, it may be provided that the downholders have an inlet for a process gas. This inlet may be formed, for example, by the sleeve shape itself of the downholders 7, with a process gas being blown and/or introduced into these sleeves.

However, the rod-shaped and/or pin-shaped downholders 7 may also be provided with such an inlet. For example, they may have channels, which may be open on the end of the downholders 7 facing the cells 3, in order to thus enable the discharge of the process gas to the welding location.

For introducing the process gas to the downholders 7, they may be provided with a connection, or a gas line may be guided into the downholders 7.

As can be seen particularly in FIG. 1, a further embodiment variant of the welding device 1 may provide that it has a laser welding device with a laser weld head 4, which is designed such that a laser beam emitted from the laser weld head reaches multiple cells 3. For example, in a position of the laser weld head 4 3 x 3 cells 3 may be covered, wherein this number is not to be understood as limiting. Thus, it is possible to weld multiple cells 3 without a relative movement of the clamping device 6 with respect to the laser weld head 4, whereby a corresponding time saving in the production of the welded connections can be realized. This may be achieved by a corresponding design and/or arrangement of the optics of the laser weld head 4.

Thus, a method for materially bonding at least one cell connector 2 to cells 3 for storing electrical energy by means of a welding device 1 can be performed, according to which a laser beam from a laser weld head 4 of the welding device 1 is directed at the cell connector 2, and the cells 3 are held in a clamping device 6, and wherein multiple cells 3 are connected to the cell connector 2 or the cell connectors 2 by means of the laser beam without the laser weld head 4 and the cell connector 6 being moved in the process. Particularly preferably, the welding device 1 described above according to at least one of the described embodiment variants is used for this.

Within the context of the invention, it is possible that only one cell 3 at a time is welded. When using deflection devices and/or beam splitters, it may also be provided that multiple cells 3 are welded simultaneously, even if only one (laser) weld head is present.

The clamping device 6 preferably has a number of downholders 7 corresponding to the number of cells 3, or a number of downholders 7 that is twice the number of the cells 3.

The invention allows for welding a cell connector 2 to individual or grouped (battery) cells 3, wherein the welding optics and the welding device 1 do not touch at any point in time.

When closing the welding device 1, each individual contact location between the cell connector 2 and the cell 3 is clamped by a force-loaded downholder 7, such that the cell connector 7 is pressed onto the cell contact without gaps at least in some sections and with a defined holding force. Additionally, these downholders 7 may compensate component tolerances, for example differences in length of the cells 3. The downholders 7 are preferably dimensioned and designed such that the laser beam, which may be deflected in the weld optics by mirrors, does not collide with the downholders 7. With this arrangement, it is possible that the weld optics can produce multiple cell contacts without changing the basic positioning in doing so.

The exemplary embodiments show and/or describe possible embodiment variants, while it should be noted at this point that combinations of the individual embodiment variants are also possible.

Finally, as a matter of form, it should be noted that for ease of understanding of the structure, the welding device 1 and/or the clamping device 6 and/or its components are not obligatorily depicted to scale.

### LIST OF REFERENCE NUMBERS

1 Welding device
2 Cell connector
3 Cell
4 Laser weld head
5 Laser light
6 Clamping device
7 Downholder
8 Downholder frame
9 Longitudinal central axis
10 Frame
11 Through hole
12 Spring
13 Surface
14 Annular web
15 Total height
16 Deflection
17 Angle
18 Cheek
19 Cheek

1-15. (canceled)

16. A clamping device (6) for simultaneously clamping a plurality of cells (3), for storing electrical energy, comprising a downholder (7), by means of which a cell connector (2) can be placed on the cell (3) or the cells (3) without gaps at least in some sections, wherein for each cell (3) a separate downholder (7) is provided, wherein the downholder(s) (7) can be tensioned against the cell (3) or the cells (3), and wherein the downholders (7) are arrangeable on two opposing surfaces of the cells (3), wherein the cells (3) are mounted so as to be pivotable or rotatable with the downholders (7).

17. The clamping device (6) according to claim 16, wherein the downholder(s) (7) are arranged or formed to be elastically tensible against the cell (3) or the cells (3).

18. The clamping device (6) according to claim 16, wherein the downholder(s) (7) have a pin-shaped or rod-shaped design.

19. The clamping device (6) according to claim 18, wherein the pin-shaped or rod-shaped downholder(s) (7) are arranged so as to be inclined against the cells (3) at an angle (17) of less than 90°.

20. The clamping device (6) according to claim 16, wherein the downholder(s) (7) have a sleeve-shaped design.

21. The clamping device (6) according to claim 20, wherein the sleeve-shaped downholder(s) (7) have a conical design at least in some sections.

22. The clamping device (6) according to claim 16, wherein the downholder(s) (7) have an inlet for a process gas.

23. A welding device (1) for welding at least one cell connector (2) to multiple cells (3) for storing electrical energy, comprising a clamping device (6) for clamping the cells (3), wherein the clamping device (6) is formed according to claim 16.

24. The welding device (1) according to claim 23, wherein it has a laser welding device with a laser weld head (4), wherein the laser weld head (4) is designed such that a laser beam emitted from the laser weld head (4) reaches multiple cells (3).

25. The welding device (1) according to claim 24, wherein it has at least two laser weld heads (4).

26. The welding device (1) according to claim 25, wherein the two laser weld heads (4) are assigned to opposing surfaces of the cells (3).

27. A method for materially bonding at least one cell connector (2) to cells (3) for storing electrical energy by means of a welding device (1), according to which a laser beam from a laser weld head (4) of the welding device (1) is directed at the cell connector (2), and the cells (3) are held in a clamping device (6), wherein multiple cells (3) are reached by the laser beam, so that multiple cells (3) are connected to the cell connector (2) or the cell connectors (2) without the laser weld head (4) and the cell connector (6) being moved, and wherein a welding device (1) according to claim 23 is used as the welding device (1).
